(19) United States
(12) Patent Application Publication
(10) Pub. No.: US 2026/0340717 A1
(43) Pub. Date: Oct. 29, 2026

(54) SYSTEM AND METHOD FOR RAPID DIGITAL RENTAL, DECENTRALIZED TRANSACTION SYNCHRONIZATION, AND ASSET SECURITY MANAGEMENT

(71) Applicants: William J. Petz, Las Vegas, NV (US); Timothy J. Calabro, Brooklyn, NY (US)

(72) Inventors: William J. Petz, Las Vegas, NV (US); Timothy J. Calabro, Brooklyn, NY (US)

(21) Appl. No.: 19/541,510

(22) Filed: Feb. 17, 2026

Related U.S. Application Data
(60) Provisional application No. 63/775,352, filed on Mar. 21, 2025.

(51) Int. Cl. G06Q 30/0645

(52) U.S. Cl. CPC G06Q 30/0645

(57) ABSTRACT

A system and method are disclosed for renting physical items in high-traffic or temporary environments using electronic devices. The system enables rapid renter identification, item assignment, and rental enforcement through contactless communication technologies, machine-readable symbols, and electronic authorization. Rental transactions are executed via a software application operating on organizer and renter electronic devices, with configurable security mechanisms including payment-based enforcement, deferred charging, and simulated transaction logic. The system supports decentralized and offline operation by synchronizing rental session data across multiple organizer devices using peer-to-peer communication without requiring continuous internet connectivity. Additional features include digital rental agreements, automated return processing, condition monitoring, messaging, analytics, and loss-prevention functionality, thereby reducing transaction time, operational risk, and reliance on physical identification in high-volume rental environments.

### CROSS-REFERENCE TO RELATED APPLICATIONS

This application claims priority to and the benefit of U.S. Provisional Patent Application No. 63/775,352, filed on Mar. 21, 2025, entitled “Rapid Rental, Point of Sale, Marketing and Break Fix System” the entire disclosure of which is hereby incorporated by reference in its entirety.

### FIELD OF INVENTION

The present invention generally relates to digital transaction and asset management systems and, more specifically, to systems and methods for rapid digital rental, decentralized transaction synchronization, and asset security management in high-volume, infrastructure-constrained, or temporary settings.

### BACKGROUND OF THE INVENTION

High-traffic environments such as festivals, live events, venues, and temporary installations frequently require the short-term rental or controlled distribution of physical assets, including wearable electronics, access equipment, tools, and consumer devices. In such environments, operators must issue and recover large volumes of assets within limited time windows while maintaining accountability, minimizing loss, and ensuring a positive user experience. Existing rental and asset-access systems, however, are often operationally inefficient, legally risky, and technically fragile when deployed under these conditions.

Many conventional rental and bailment systems rely on manual reconciliation processes, centralized databases, or physical collateral practices, such as retention of personal identification documents. These approaches can introduce legal exposure, staffing overhead, and transaction delays, particularly during peak demand periods. Moreover, physical collateral handling is poorly suited to high-throughput environments where speed, scalability, and reduced friction are critical.

Cloud-dependent rental platforms typically require persistent internet connectivity to maintain centralized inventory records and transaction state. In real-world event conditions, cellular congestion, intermittent connectivity, or complete network outages are common. Under such circumstances, delayed or failed synchronization can result in inconsistent item states, double rentals, asset loss, and prolonged reconciliation processes. The reliance on centralized servers also introduces single points of failure that can disrupt entire rental operations.

Damage detection and condition verification in existing systems are frequently performed through manual inspection or cloud-based analysis. Manual inspection is subjective and inconsistent, while cloud-based solutions often require uploading high-resolution images or video for remote processing, increasing latency, bandwidth consumption, and data privacy risk. These limitations are particularly problematic in high-density environments where rapid turnover and constrained connectivity are the norm.

Furthermore, many existing solutions function primarily as passive bailment systems that track possession without executing active rental logic. Such systems often lack integrated point-of-sale enforcement, automated rental timing, overage charging, or real-time loss-prevention mechanisms. As a result, operators are left with limited tools to manage accountability, deter misuse, or enforce rental terms dynamically.

Accordingly, there exists a need for a rapid, point-of-sale rental system capable of operating reliably without continuous internet connectivity, synchronizing data across multiple devices without reliance on a centralized server, and executing active rental transactions with integrated enforcement. There is further a need for such a system to incorporate decentralized synchronization, on-device condition analysis, and automated deterrence and loss-prevention mechanisms directly into the rental workflow, thereby reducing operational bottlenecks, mitigating legal and technical risk, and improving the overall rental experience for both operators and renters.

### SUMMARY OF THE INVENTION

The present disclosure addresses one or more disadvantages of existing rental and bailment practices and provides additional benefits as described herein. Specifically, the embodiments described herein resolve issues of inefficiency, technical vulnerability, and legal exposure associated with manual processing, physical collateral methods, and reliance on persistent internet connectivity in high-volume rental scenarios. Other features and advantages are realized through the methods and systems described below, and additional embodiments and aspects are considered to be within the scope of the invention.

In one embodiment, the present invention offers a system and method for optimizing the rental process for organizers and renters in high-traffic or temporary settings. The system is realized through software running on one or more electronic devices used by organizers and renters. Organizers can create an account using an electronic device and set up an organizer account with organizer profile information such as rental terms, session details, pricing, messaging templates, and security preferences. Organizers can post and establish one or more rental sessions based on particular dates, times, or locations or events.

Renters can be registered prior to or during an event by entering a renter identifier by scanning or touching a personalized code or electronic device with an electronic reader, or by manually entering identifying information such as an email address, phone number, or payment information. Renter information can be used for deposits, payments, communications, and accountability and can be linked to one or more rental items. In some embodiments, the system automatically determines whether a renter interaction is associated with a check-in or a check-out based on session state and item status.

Upon receiving a rental request from a renter, the system links the renter identifier to at least one rental item and performs a rental transaction. The transaction may comprise steps such as displaying a customized digital rental agreement on the renter's electronic device for electronic acceptance, using monetary or non-monetary collateral, and performing payment processing, deposit handling, or simulated deterrence logic as configured by the organizer. In certain embodiments, the entire process from renter identification to item assignment may be completed in a matter of seconds, for example approximately eleven seconds.

The system enables active enforcement of rental transactions, including timed rentals, overage assessments, loss fees, and configurable security enforcement policies. Payment details may be received via the renter electronic device and processed through the organizer electronic device, a local transaction handler, or an optional remote server. In certain embodiments, the organizer electronic device communicates with one or more third-party payment gateways to authorize, validate, hold, defer, or simulate financial transactions. The payment and enforcement mechanisms are integrated directly into the rental workflow, enabling automated application of rental conditions without requiring manual reconciliation.

In one embodiment, the system comprises a communication architecture enabling organizer electronic devices and renter electronic devices to communicate within a decentralized network. The network may utilize peer-to-peer communication technologies including Bluetooth, Bluetooth Low Energy (BLE), Bluetooth Mesh, Wi-Fi Direct, or combinations thereof. In certain implementations, rental transactions, renter associations, and item state transitions are executed locally on organizer electronic devices and synchronized directly among devices without requiring continuous internet connectivity. When connectivity to a remote server becomes available, locally stored session data may optionally be uploaded for backup, reconciliation, analytics, or reporting purposes.

The system further enables on-device condition capture and analysis. Images or video of rental items may be captured at check-out, during usage, or at return using imaging components of the organizer electronic device. A computer vision module executing on the device may perform comparison analysis to detect changes in item condition, including damage, defects, or anomalies, without requiring transmission of captured media to a remote server. This architecture reduces latency, bandwidth consumption, and exposure of sensitive visual data.

In other embodiments, the system combines deterrence and loss prevention methods such as simulated payment confirmation, automated messaging, and optional coupling with egress monitoring hardware to detect unreturned items leaving a controlled area. Security alerts and changes in rental status can be distributed to multiple organizer devices via the decentralized communication network.

Together, the disclosed system and method offer a robust, high-throughput, and scalable digital rental solution that is able to function within an offline or intermittently connected environment, as well as facilitate rapid point-of-sale rental transactions, decentralized synchronization, accountability, and asset protection.

### BRIEF DESCRIPTION OF THE DRAWINGS

The foregoing summary, as well as the following detailed description of the invention, is better understood when read in conjunction with the appended drawings. For the purpose of illustrating the invention, exemplary constructions of the invention are shown in the drawings.

However, the invention is not limited to the specific methods and structures disclosed herein. The description of a method step or a structure reference by a numeral in a drawing is applicable to the description of that method step or structure shown by that same numeral in any subsequent drawing herein.

FIG. 1 illustrates a flow diagram of an example method for performing a rapid digital rental transaction using electronic devices, including organizer account creation and session configuration, renter identification through multiple registration pathways, assignment and management of rental items, optional payment or enforcement determination, electronic acceptance of a rental agreement, completion of a rental transaction, and return or reconciliation of rented items, in accordance with one or more embodiments of the present disclosure.

FIG. 2 is a schematic diagram illustrating an example system architecture and electronic communication framework for a digital rental system, including organizer electronic devices, optional application server components, peer-to-peer synchronization, and integrations with third-party services for payment processing, messaging, and renter identification.

### DETAILED DESCRIPTION OF THE INVENTION

It is to be noted that the above disclosure is not limited in its application to the details of construction, arrangement of components, and specific embodiments described in the above disclosure or illustrated in the accompanying drawings. The above disclosure is capable of other embodiments and can be practiced or carried out in various ways. The phraseology and terminology used in the above disclosure are for the purpose of description and should not be construed as limiting. The terms “including,” “comprising,” or “having,” and variations thereof, are intended to encompass the items listed thereafter and equivalents thereof, as well as additional items. The terms “a” and “an” indicate the presence of at least one item. The terms “first,” “second,” and “third” are used only for distinction and do not imply order, quantity, or importance. The term “about” indicates a value within an acceptable tolerance range.

For purposes of the present disclosure, the term “organizer” refers to any individual, entity, or system authorized to configure, manage, or operate a rental session using the disclosed system. The term “renter” refers to any user, customer, participant, or device associated with a rental transaction for one or more items. The term “rental session” refers to a defined temporal, spatial, or logical grouping of rental activity, including one or more renters, rental items, and associated transaction rules. The term “simulated payment” refers to a deterrence or enforcement mechanism that represents or mimics payment authorization or confirmation without necessarily executing an actual financial transaction. Unless otherwise stated, these terms are intended to be non-limiting and inclusive of functional equivalents.

Although certain embodiments are described herein with reference to mobile electronic devices such as smartphones or tablets, the disclosed system and methods are not limited to any particular hardware form factor. The functionality described herein may be implemented using kiosks, wearable devices, embedded controllers, handheld scanners, point-of-sale terminals, dedicated rental hardware, or other computing devices capable of executing the disclosed operations. Accordingly, references to specific device types are exemplary and not intended to limit the scope of the invention.

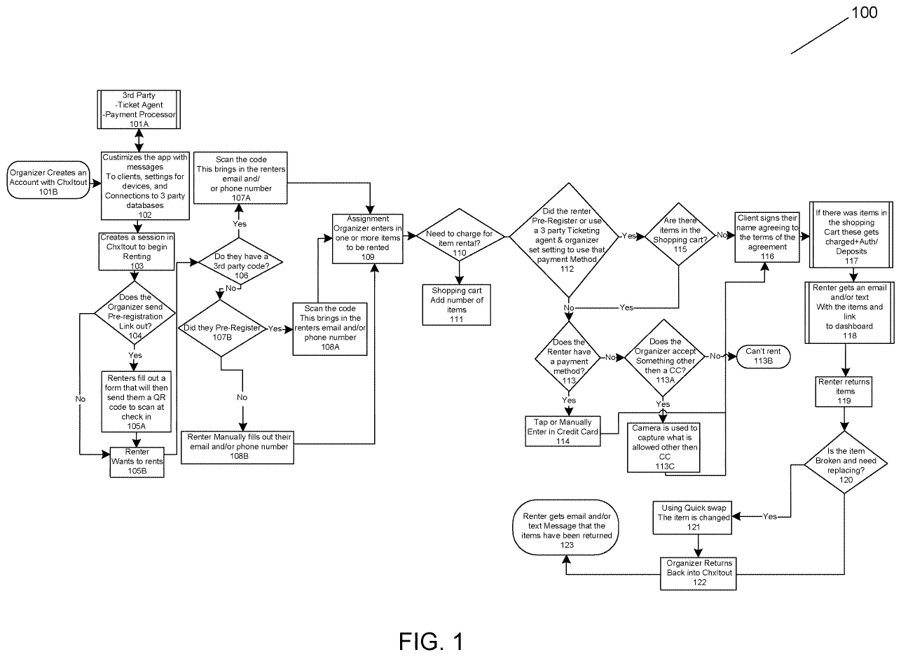

Referring now to FIG. 1, a flowchart illustrating an example method 100 for executing a rapid digital rental transaction and asset management workflow according to one or more embodiments of the present disclosure is disclosed. The method 100 is configured to operate in high-throughput environments and supports concurrent rental sessions, decentralized device synchronization, flexible renter identification, and configurable financial enforcement mechanisms.

The process 100 begins at step 101B, where an organizer creates an account or profile using an organizer electronic device through an application programming interface (API) of the rental application. During account creation, the organizer may configure profile-level preferences including messaging templates, branding assets, rental rules, enforcement policies, and item categories. In certain embodiments, the organizer profile may be linked to one or more third-party service providers 101A, including payment processors, ticketing platforms, credential verification services, or messaging gateways. At step 102, the organizer configures rental management parameters, including uploading item identifiers or images, defining scanning logic, and customizing renter communications. The organizer then establishes one or more rental sessions at step 103, each session being associated with a specific event, location, time period, or grouping of rental items. Session data is configured for synchronization across multiple organizer devices associated with the same organizer profile. In some embodiments, the application allows the creation of multiple organizer profiles, each with distinct configuration settings, enabling simultaneous management of different events. To reduce configuration errors, each session may be assigned a machine-readable session identifier, allowing rapid and accurate association of organizer devices with the correct session.

After the formation of the session, renter registration can take place via one or more alternative methods of identification. In one variant, a pre-registration link 104 is sent from the organizer device to the renter device, allowing the renter to enter their identification and contact information in advance. Upon successful entry, a machine-readable identifier 105A is created and shown on the renter device for fast-track check-in at the rental site. In other variants, renter identification can be completed by scanning/tapping a third-party credential/NFC device 106, followed by device interaction 107A, or by entering renter information 108B manually on the organizer device. Where applicable, renter identifiers can be automatically filled from third-party ticketing or credentialing systems 101A. The app can store renter identifiers for later use, allowing for express check-in 108A. In some variants, bulk renter registration is possible via organizer-uploaded lists, leading to the creation and distribution of individual machine-readable identifiers through electronic or physical means. The app can also ask the renter to enter additional verification information, such as short audio or video recording, to link identity verification to the rental transaction.

Following renter registration, the organizer assigns one or more rental items to the renter at step 109. The renter can change the selection by adding additional items 111 or substituting selected items 110 before finalizing through a virtual cart interface. The application obtains renter identification and payment information, if available, from pre-registration data 112, third-party credentials, or manual entry 114. At steps 113 through 113c, the application checks for the availability of an acceptable payment method according to organizer-defined parameters, such as card entry, tap-to-pay, or other wireless transaction methods. Without an acceptable payment method 113b, the rental transaction may be disapproved. In some implementations, the application has the ability to perform wireless digital transactions without the need for external payment devices. The system also provides for multiple configurable enforcement options, such as simulated payment, held funds, pre-authorized holds, and charge-on-loss logic, for deterrence and risk management purposes without the use of physical identification.

During the rental period, the application may collect usage and interaction data associated with the rental session, including rental duration, item state transitions, renter interactions, and device events. In some embodiments, analytics modules evaluate behavioral patterns to detect anomalies, identify potential misuse, or flag renter identifiers associated with prior incidents. Notifications or alerts may be generated on organizer electronic devices to assist in decision-making during subsequent rental transactions. For battery-powered rental items, the system may further track estimated battery levels and restrict assignment of items below organizer-defined thresholds.

Upon expiration of the rental period, the system may generate a return notification transmitted to the renter electronic device. If a rented item is identified as malfunctioning at step 120, the organizer may initiate a quick swap operation 121, enabling substitution of the item without requiring renter re-registration. Returned items may be evaluated and assigned updated operational states, including returned, damaged, defective, restricted, or flagged. Such state transitions may be recorded with associated metadata, including condition data, timestamps, and organizer annotations. Return processing may be performed using machine-readable scanning, NFC interaction, continuous return mode, or bulk reconciliation workflows. Automated confirmation messages 122 may be transmitted to the renter electronic device upon successful completion. In offline implementations, return transactions and updated item states may synchronize directly among organizer electronic devices. When internet connectivity is restored, locally stored updates may optionally synchronize with a remote server.

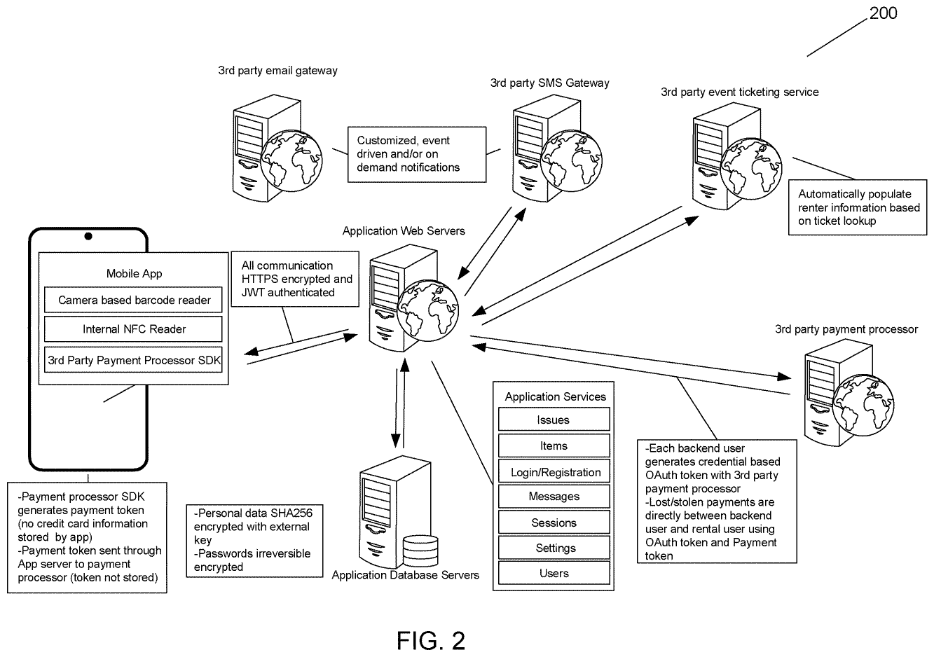

Referring now to FIG. 2, a schematic illustration of a system architecture example for practicing the above-disclosed rapid digital rental and asset security management system is shown. As can be seen, the system comprises one or more organizer electronic devices 201a running a downloadable software application as described herein. The organizer electronic devices 201a may comprise smartphones, tablets, or other computing devices capable of executing the application and facilitating contactless communication, scanning, and wireless data transfer.

In some embodiments, the organizer electronic devices 201a are designed to communicate directly with each other using peer-to-peer communication technologies such as, but not limited to, Bluetooth, Bluetooth Low Energy (BLE), Bluetooth Mesh, Wi-Fi Direct, or any combination thereof. This allows for a decentralized communication infrastructure that facilitates synchronization of rental sessions, item status, renter associations, and transaction information among multiple organizer devices without necessarily being connected to the application server 201 continuously.

In the event that internet connectivity is available, one or more organizer electronic devices 201a may optionally synchronize session data with the application server 201 for purposes of backup, reporting, reconciliation, analysis, or long-term storage. The application server 201 is not required for real-time rental execution and is not a single point of failure for rental operations.

The application server 201 can be set up to communicate with one or more third-party service providers, such as a third-party email gateway 201b, a third-party SMS gateway 201c, third-party event ticketing services 201d, and a third-party payment processor 201e. These services can be accessed through application programming interfaces (APIs) to enable messaging, renter identification, ticket verification, and payment authorization. In some embodiments, renter identifying information can be automatically populated as a result of credential or ticket verification by the third-party event ticketing services 201d.

Payment processing can be carried out through token-based authorization offered by the third-party payment processor 201e. Payment tokens or authorization tokens can be created on a renter's electronic device or an organizer's electronic device and sent securely without storing the sensitive payment information on the application server 201. Communication between organizer devices 201a and the application server 201 can be encrypted using secure communication protocols such as HTTPS and authenticated using token-based authentication techniques such as JSON Web Tokens (JWT).

The organizer electronic devices 201a may also comprise integrated hardware components such as cameras, NFC readers, Bluetooth radios, and other sensors that facilitate the scanning of machine-readable symbols, contactless identification, and image/video capture for item condition monitoring. In some embodiments, condition analysis and damage assessment are done on the organizer electronic devices 201a without transmitting the captured media to a remote server.

The system may also comprise one or more application database servers 201f for storing session information, renter identifiers, item information, transaction data, messaging templates, and configuration parameters. Security measures may comprise hashing or encrypting personal information using cryptographic techniques such as SHA-256, hashing of authentication information, and logical segregation of renter identity information, transaction information, and item status information.

Renter registration can be done through various channels based on event settings. In one variant, a pre-registration link is offered to renters, enabling them to provide identifying information such as name, email address, phone number, and payment details before the event. After which, a machine-readable code is automatically generated on the renter's electronic device for quick entry. In other variants, renters can register in-person by scanning a third-party machine-readable code, tapping an NFC device, or manually inputting their information into the App. Renter identifiers can also be obtained from third-party sources such as ticketing platforms. Thereafter, the renter information is sent to the organizer's device or server and linked to the corresponding event.

In one embodiment, the system provides a flexible renter registration system architecture that is capable of linking a renter to one or more rental transactions via electronic identification methods. Registration can be done before or during a rental session and may involve the reception of identification information through pre-registration links, machine-readable symbols, contactless communication, or manual entry. The system links the received identifier to a session-specific renter data and provides access to the information on all organizer devices via local or decentralized synchronization. The registration logic can automatically identify whether a renter interaction is a check-in or check-out based on item status and session context.

After the registration process, the renter can place a request to rent one or more items. Every rental item is given a distinct identifier, which can be manually keyed in, scanned from a barcode or QR code, recognized through NFC or BLE, or read using Optical Character Recognition (OCR). The system links the renter identifier to the rental item of choice and displays a personalized digital rental contract on the renter's electronic device for electronic signing. Once signed, the rental transaction is completed. In some embodiments, the entire process, from renter identification to item assignment, is accomplished in a significantly shorter transaction time, such as approximately eleven seconds.

In one embodiment, each rental item is subject to a state machine that is defined and consists of a number of operational states such as, but not limited to, available, checked out, flagged, damaged, restricted, lost, and returned. The transition of the states is automatically controlled by the system as a result of actions performed by renters, organizers, expiration of time, or problems detected. Some transitions may be disallowed or forbidden, such as transitioning an item that is flagged as damaged or restricted to a new renter. The system maintains the state transitions in relation to renter identifiers and session information. State transitions may be triggered automatically based on device events, elapsed time, condition analysis, or enforcement rules.

In certain embodiments, the system is designed to facilitate high-throughput rental scenarios by reducing the number of transaction steps and background processing. The system is also able to handle multiple simultaneous rental transactions among organizer devices, with a consistent state of items being maintained. The time taken for transactions, concurrency of devices, and duration of offline usage can be adjusted based on system settings and hardware specifications.

In one embodiment, the system comprises a configurable transaction and payment enforcement layer that supports multiple security and settlement mechanisms. Payment details can be received from the renter's electronic device and processed using a payment gateway, tokenized service, or local transaction handler. Depending on the organizer's configuration, the system can perform immediate charges, held deposits, pre-authorized validations, deferred charges, or simulated payment confirmations to serve as a deterrent without actually performing a financial transaction. Payment and enforcement logic are directly integrated into the rental process and can be automatically triggered based on rental time, return status, or loss detection.

The system enables active point-of-sale rental enforcement as opposed to passive bailment tracking. The rental logic may comprise of timed rentals, overage fees, loss fees, or a combination thereof. The payment details could be processed via third-party payment gateways using secure tokens, or alternatively, via simulated payment logic designed to offer a psychological deterrent without effecting a real payment transaction. Security options available for selection by the organizer could be comprised of simulated payment confirmation, held funds, pre-authorized holds, or charge-on-loss options. In addition to payment-based security, the system could also capture non-payment collateral such as images, video clips, audio files, or biometric data.

The system also offers a renter dashboard that can be viewed on the renter's electronic device, showing active rentals, return status, outstanding items, and corresponding notifications. An express machine-readable code can also be produced for use in future rentals, facilitating faster transactions. Messaging capabilities enable organizers to send automated or manual messages through SMS or email for rental confirmations, return reminders, overage notifications, or marketing.

Condition monitoring and problem resolution are enabled by image or video capture at checkout and return. In one embodiment, a computer vision module on the device performs a comparison analysis of pre-and post-rental media to identify damage such as scratches, cracks, or missing parts without uploading media to a remote server. Problems identified can be recorded, flagged, and viewed in a “Manage Issues” dashboard for review by the organizer.

Rental items can be identified as damaged, defective, or restricted, preventing reassignment until the problem is resolved. A quick-swap functionality enables organizers to substitute items that are not functioning without requiring renter re-registration.

In some embodiments, the system uses predictive and condition-based analytics to forecast possible failures of items. High-resolution images, videos, or other condition monitoring data captured during the checkout and return process can be analyzed locally or through machine learning algorithms to identify early indicators of degradation, damage, or malfunction. The system can identify items that are likely to fail based on usage patterns, past performance, or anomalies and enable the organizers to replace, repair, or withdraw such items from the rental pool in advance. This predictive maintenance feature can be achieved without the need to upload data to a central server.

The system comprises analysis and reporting capabilities that allow the organizer to monitor rental activity, usage trends, battery life, session times, peak concurrency, and historical item performance. Anomalous behavior or renters with a history of problems can be detected by machine learning or rule-based logic. When a flagged renter tries to rent again using related identifiers, notifications can be shown to the organizer for review.

The return workflows are designed for high-volume handling. Quick return options enable single-click or continuous scanning of items for immediate reconciliation. The bulk return feature can be applied where scanning is not feasible. Automated notifications can be sent to the renters for the outstanding items, and confirmations can be sent upon successful return. The overage or loss fees can be automatically applied based on the rental terms.

In certain embodiments, the system is coupled with exit area detection systems to detect rental items exiting a controlled area. These systems can include RFID readers, Bluetooth or BLE signal monitors, NFC scanners, or other proximity-sensing devices. Upon detecting an item exiting without a corresponding completed return transaction, the system can send alerts to organizer devices, automated notifications to the renter, or initiate other verification procedures. This allows for real-time loss prevention without the need for manual item inspections at the exit area.

The application supports offline functionality and decentralized synchronization among organizer electronic devices. Each organizer electronic device may maintain a local copy of rental session data, including renter associations, item states, and transaction records.

Synchronization may occur directly among organizer electronic devices using peer-to-peer communication protocols. Upon restoration of connectivity with a remote server, locally stored data may optionally upload for backup, reporting, reconciliation, or analytics. In certain embodiments, synchronization occurs without reliance on a continuously available centralized server.

In one embodiment, organizer electronic devices participating in a rental session may assume logical roles including primary, secondary, or peer devices. To prevent conflicting transactions, the system may temporarily lock rental items during check-out or return operations. In the event of synchronization conflicts, resolution logic may utilize timestamps, device priority, session authority, or last-confirmed item states. This ensures that each rental item is associated with only one renter at a time and maintains consistent item status across decentralized devices.

In addition to the rental transaction flow described with reference to FIG. 1, the system may further execute one or more auxiliary methods, including but not limited to decentralized synchronization, conflict resolution among organizer devices, payment enforcement, or rental state reconciliation. Such methods may operate independently or concurrently with the primary rental flow and may be triggered by device connectivity changes, simultaneous transactions, or enforcement conditions. These auxiliary methods may be implemented as software routines, background processes, or rule-based logic without departing from the scope of the present invention.

In one example, the system uses a privacy-preserving data architecture where personally identifiable information, transactional information, and item status information are logically decoupled. Sensitive renter data can be encrypted on organizer devices, and media taken for condition monitoring can be processed locally without being sent to remote servers. Organizer-controlled encryption keys and token-based payment processing minimize the risk of sensitive data exposure while facilitating secure synchronization and reporting. The data architecture enables the system to function with less reliance on cloud infrastructure while still being flexible with data compliance.

In certain embodiments, the system further includes referral tracking and commission logic. Organizers can generate referral codes or links for new potential organizers, which can be associated with the referring organizer's account. When a new organizer registers using a referral code or link, the system automatically records the referral association and can optionally track referral performance, commissions, or attribution for future events. Referral information can be stored locally on the organizer's device, synchronized across organizer devices, and optionally transmitted to a centralized server for reporting or accounting purposes. This feature allows organizers to promote the system and receive credit or benefits for new user acquisition without impacting the core rental workflow.

While the invention has been described with reference to specific embodiments, the foregoing description is intended to illustrate and not limit the scope of the invention. Modifications, variations, and equivalents will be apparent to those skilled in the art and are intended to fall within the scope of the appended claims.

1. A system for renting physical items in a high-traffic environment, comprising:
an organizer electronic device executing a software application;
at least one renter electronic device;
a rental session comprising a logical grouping of rental items, renter identifiers, and transaction data;
wherein the system is configured to operate without requiring continuous internet connectivity, the software application being configured to:
receive renter identification information via at least one of a pre-registration link, machine-readable symbol, contactless communication, or manual entry;
associate the renter identification information with the rental session and at least one rental item;
assign a uniquely identifiable rental item to the renter;
present a digital rental agreement for electronic authorization;
enforce rental conditions comprising at least one of timed usage, overage assessment, loss assessment, or security enforcement; and
synchronize rental session data among a plurality of organizer electronic devices without requiring continuous internet connectivity.

2. The system of claim 1, wherein security enforcement comprises at least one of a simulated payment confirmation, held funds, pre-authorized validation, deferred charge, or charge-on-loss mechanism.

3. The system of claim 1, wherein each rental item is governed by a plurality of predefined operational states, and wherein transitions between the operational states are automatically restricted based on item condition or session rules.

4. The system of claim 1, wherein the organizer electronic devices synchronize rental data using peer-to-peer communication protocols and apply conflict-resolution logic to prevent duplicate item assignments.

5. The system of claim 1, further comprising on-device image or video analysis configured to compare pre-rental and post-rental condition of the rental item.

6. The system of claim 1, wherein renter data is encrypted locally and payment information is processed using token-based mechanisms without storing raw payment credentials.

7. A method for renting physical items using electronic devices, comprising:
establishing a rental session on an organizer electronic device;
receiving renter identification information;
associating the renter identification information with a rental item;
presenting a digital rental agreement for authorization;
enforcing rental conditions during a rental period;
processing a return transaction; and
synchronizing rental session data across multiple organizer electronic devices without requiring continuous internet connectivity.

8. The method of claim 7, further comprising detecting a rental item exiting a controlled area without a completed return and generating an alert.

9. The system of claim 1, wherein the renter electronic device displays a dashboard comprising rental status, outstanding items, and automated notifications.

10. The system of claim 1, wherein a machine-readable symbol is generated for subsequent rentals to enable expedited transactions.

11. The system of claim 1, wherein organizer electronic devices temporarily lock one or more rental items during assignment to prevent concurrent transactions.

12. The system of claim 4, wherein the conflict-resolution logic utilizes at least one of timestamps, device priority, session authority, or last-confirmed item states.

13. The system of claim 1, wherein rental transactions are executed locally on organizer electronic devices prior to synchronization.

14. The system of claim 3, wherein assignment of a rental item is automatically restricted when the item is in a damaged or restricted state.
